(19) United States
(12) Patent Application Publication
(10) Pub. No.: US 2004/0135975 A1
(43) Pub. Date: Jul. 15, 2004

(54) MULTI-FUNCTION PROJECTION SYSTEM

(76) Inventor: Sze-Ke Wang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,047

(22) Filed: Sep. 3, 2003

(30) Foreign Application Priority Data
Dec. 10, 2002 (TW) 091136056

(51) Int. Cl. G03B 21/14

(52) U.S. Cl. 353/84

(57) ABSTRACT

The present invention is to provide a multi-function projection system in which yellow beam passes through red and green filters by means of coating, and is cut off by a band-cut filter. Then, a driver selectively brings the band-cut filter into or off the light path. Therefore, the projection system will be selected whether it covers the strong yellow beam in red and green beam or not, so that the screen achieves optimum brightness for use in a briefing, or achieves optimum color saturation for use in enjoying movies. Thus, one projection display has multi-function uses for selecting.

### BACKGROUND OF INVENTION

1. Field of the Invention

The present invention relates to a projection system, and more particularly to a multi-function projection system.

2. Description of the Prior Art

To project in a larger conference or with light, the brightness of current projector for briefing has high lightness is better. But the general home projector as playing the films or movies wants the images to be color saturation. Therefore, it is quite difficult that one projector has two modes or more and each has optimum performance to meet the different need.

Referring to FIG. 1, a projector of the prior art mainly uses a high power lamp 11 which provides a light beam to impinge into a rotational color wheel 12. By means of a red, a blue, and a green filter 121, 122, 123 of the color wheel 12, the light beam is sequentially filtered into three primary colors and, then, passes through a uniform device 13 to form a luminous light beam of the projector.

The high power lamp 11 mainly uses a mercury high pressure lamp, e.g. a metal halide lamp or a ultra high pressure lamp. Because of the mercury atom, it excites a spectrum with strong yellow beam (the wavelength is about 578 nm). For example, FIG. 2 is the spectrum energy distribution of a 100 W ultra high pressure lamp, wherein real line is the spectrum energy distribution and three different dotted lines are the transmissivities of the red, the blue, and green filter 121, 122, 123 of the color wheel 12. By means of different transmissivities of different filters, the light beam can be filtered into three primary colors to form a color saturation image. However, the yellow beam is between the red and green beam. As filtering the red and green beam without eliminating the yellow beam, the yellow beam can rise the projection image brightness, but lower the projection color saturation. In contrast, as shown in FIG. 3, as eliminating the strong yellow beam covered in the red and green beam, shown as inclined lines, the projection color saturation can rise, but cause the energy lost and lower the projection image brightness.

Therefore, current projector is balanced with the quantity of the yellow beam coving to provide a projector adapted for briefing and for enjoying two modes. But this way can't meet the professional consumer's need that a set has multi-function selectivity.

### SUMMARY OF INVENTION

An object of the present invention is to provide a multi-function projection system which includes a band-cut filter to selectively filter the yellow beam so that one set is adapted to multi-function.

Another object of the present invention is to provide a multi-function projection system which has different band-cut filters driver for use in different projection system to extend various applicable fields.

Still another object of the present invention is to provide a multi-function projection system which uses different band-cut filters to filter different quantity yellow beam so that can choice more color modes.

To achieve the above and other objects, the present invention provides a projection system in which yellow beam passes through red and green filters by means of coating, and is cut off by a band-cut filter. Then, a driver selectively brings the band-cut filter into or off the light path. Therefore, the projection system will be selected whether it covers the strong yellow beam in red and green beam or not, so that the screen achieves optimum brightness for use in a briefing, or achieves optimum color saturation for use in enjoying movies. Thus, one projection display has multi-function uses for selecting.

### BRIEF DESCRIPTION OF DRAWINGS

The above and other objects, advantages, and features of the present invention will be understood from the following detailed description of the invention when considered in connection with the accompanying drawings below.

FIG. 1 is a schematic view showing a ruminating system of the prior art projector.

FIG. 2 is a diagram showing a spectrum energy and filter of a prior art projection system for briefing.

FIG. 3 is a diagram showing a spectrum energy and filter of a prior art projection system for enjoying.

FIG. 4 is a schematic view showing a light path of the present invention.

FIG. 5 is a diagram showing a spectrum of a yellow filter of the present invention.

FIGS. 6(A)-(D) show different projection spectrum modes of the present invention.

FIG. 7 is a schematic view showing a band-cut filter of one embodiment of the present invention.

FIG. 8 is a schematic view showing a band-cut filter of another embodiment of the present invention.

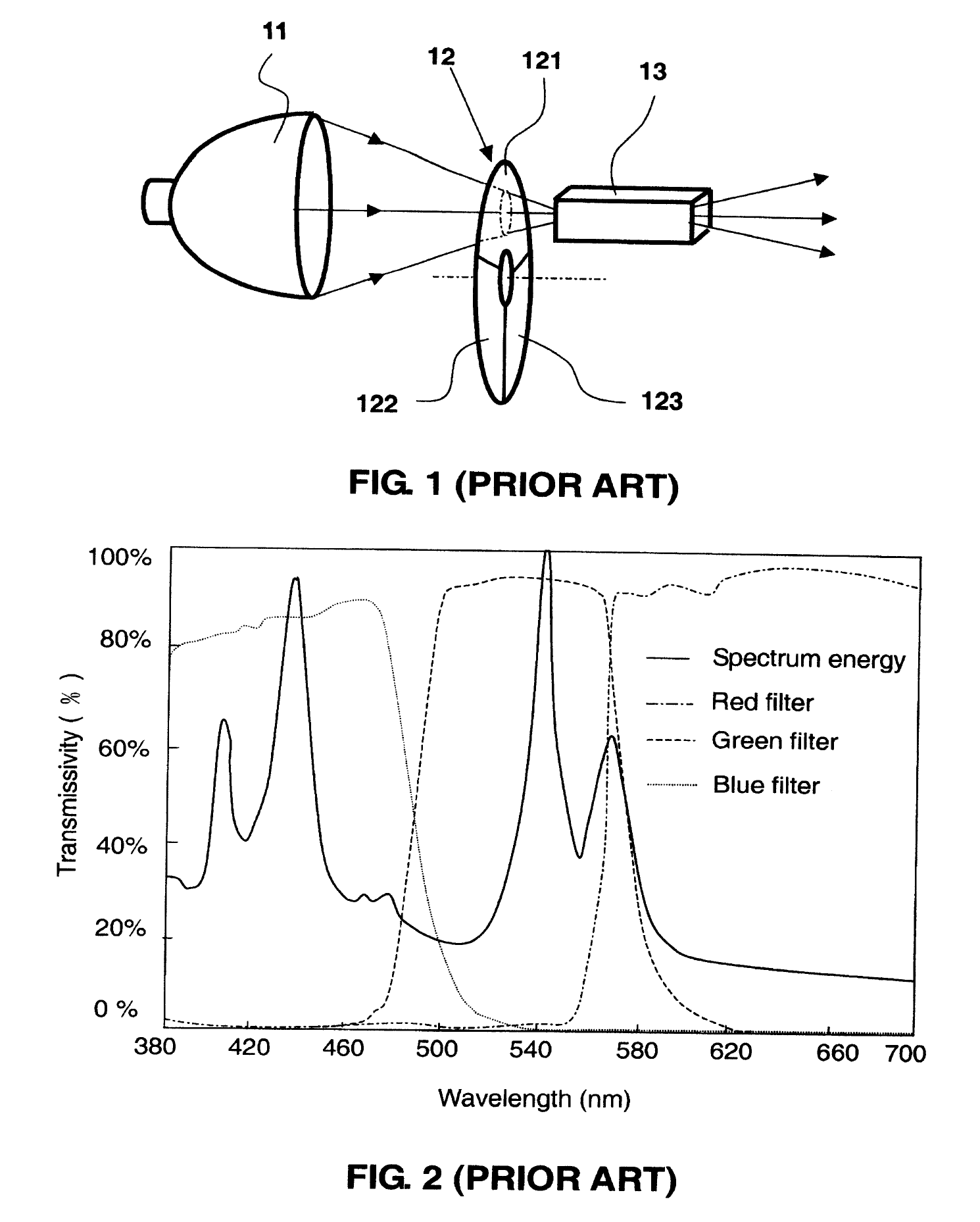

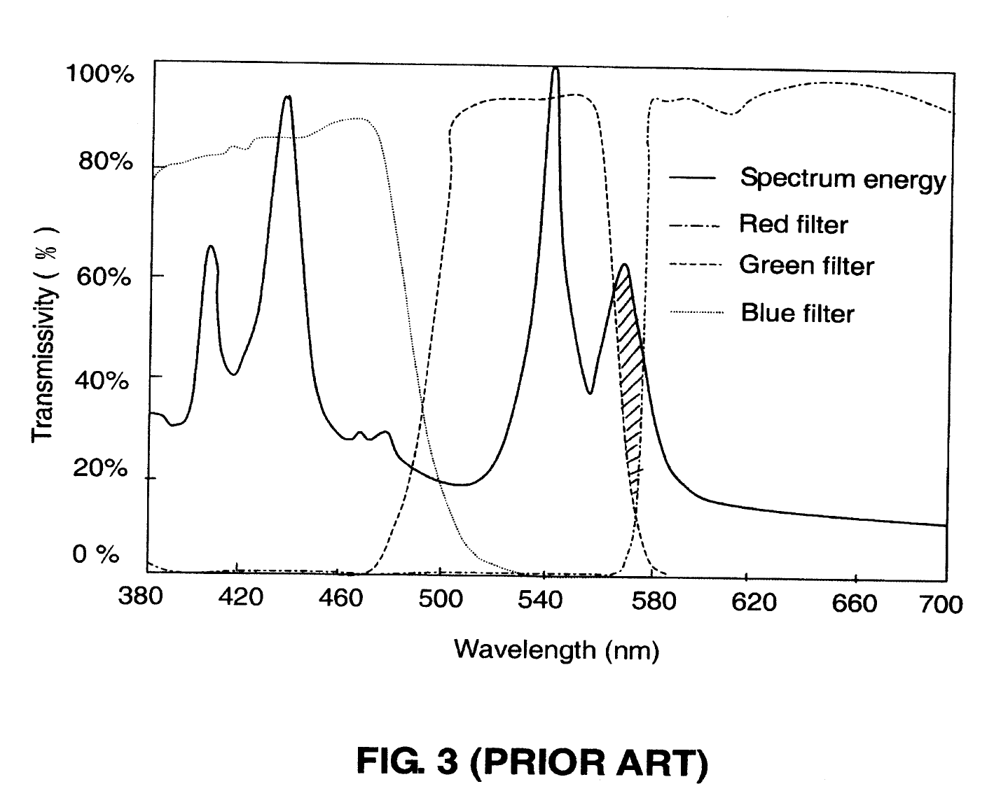

### DETAILED DESCRIPTION

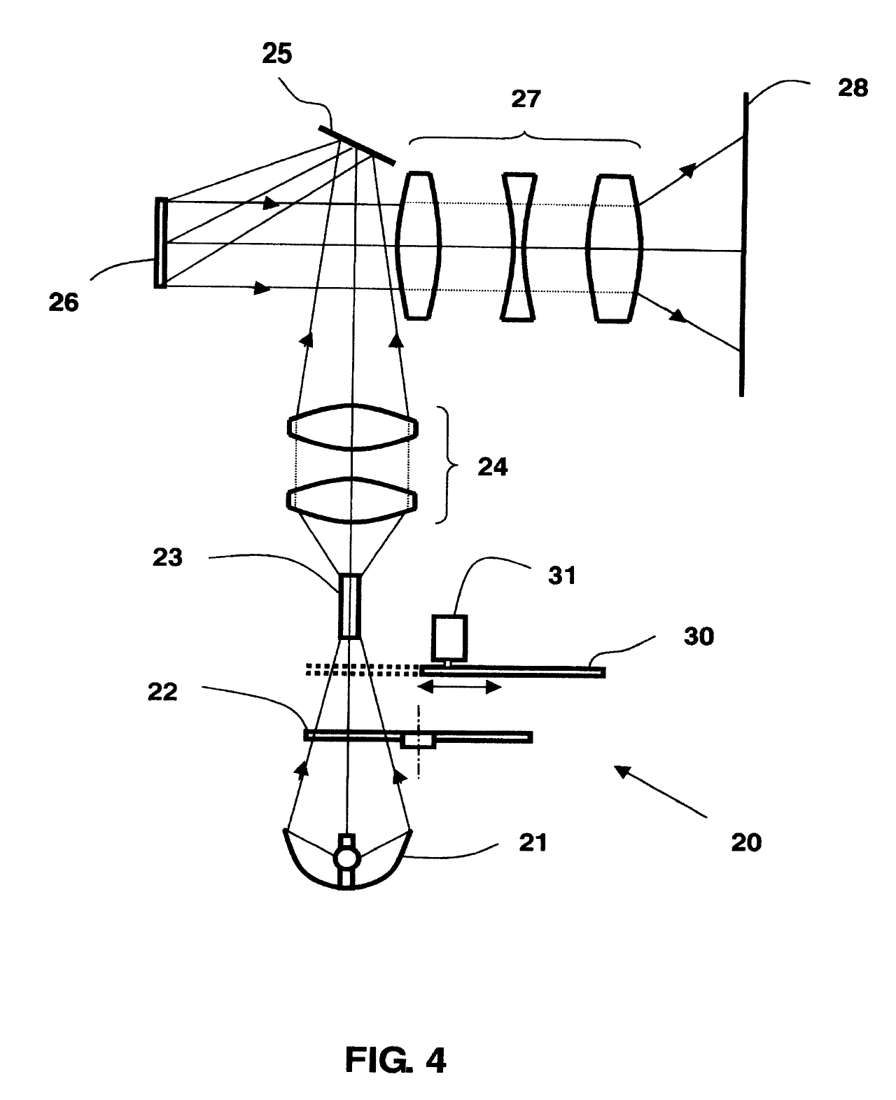

Referring to FIG. 4, a projection system 20 comprises a light source 21 providing a light beam. The light beam converges and projects into a color generation assembly 22 (e.g. color wheel, color drum, sequential color recapture, and scanning prism) which has at least one red beam, one blue beam, and one green beam filter segment to filter the light beam into a red, a blue, and a green beam. Then, the light beam passes through a yellow band-cut filter 30 which has at least one yellow beam filter segment and is driven by a driver 31 (e.g. a motor or a manual transmission). The band-cut filter can be movable into or out of the light path of the light beam in accordance to the demand. Then, the light beam impinges into an integration rod 23 to well mix and sequentially into an illuminating lens assembly 24 to converge the light beam to impinge onto a reflection mirror 25. By means of the reflection mirror 25 to reflect the light beam into a light valve 26 (e.g. a digital micro-mirror device, a liquid crystal on silicon or a LCD panel), the light beam is re-reflected by the light valve 26 into a projection lens 27 and, finally impinges onto a screen 28.

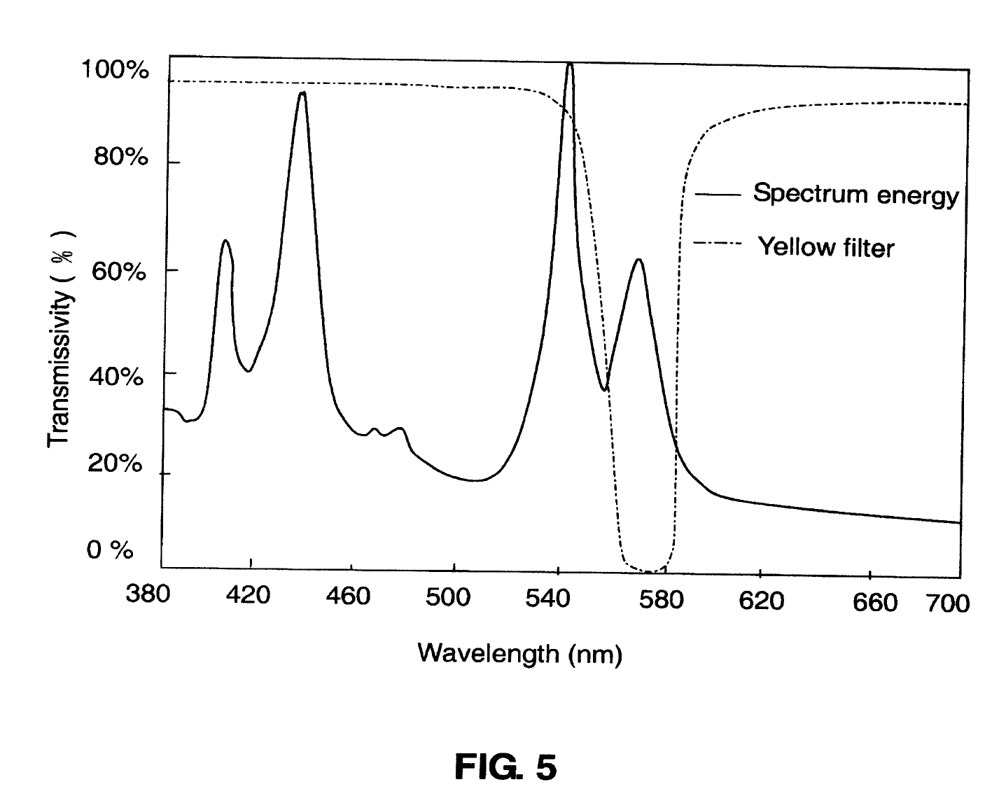

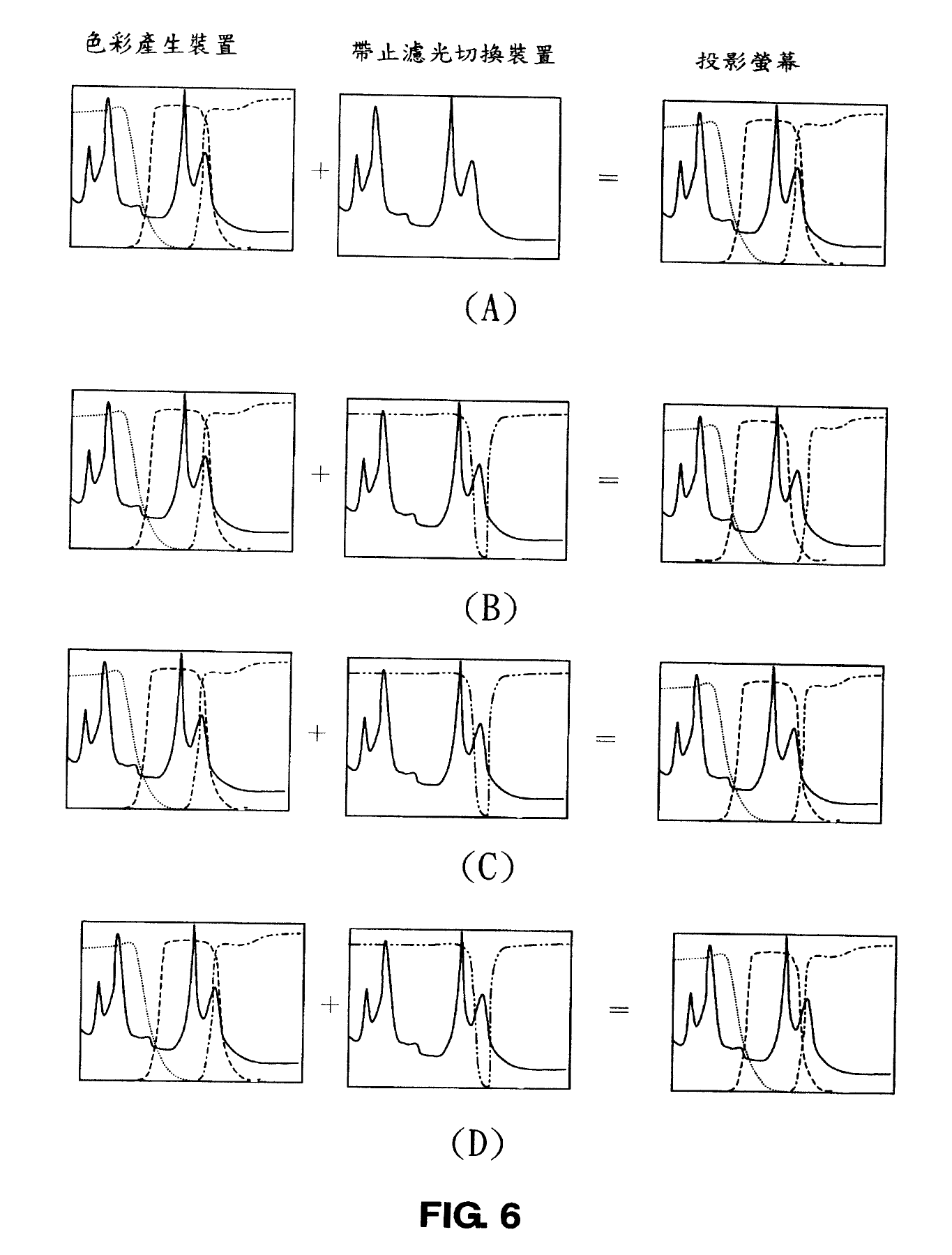

The present invention utilizes coating, as the light beam passes through the color generation assembly 22, to cover the yellow beam within the red beam and the green beam, which means the yellow beam free passes through the red filter and green filter respectively. That is, the transmissivity position of the cut out of the green filter is larger or equal to the 578 nm wavelength, and the transmissivity position of the cut in of the red filter is less or equal to the 578 nm wavelength. In addition, utilize the band-cut filter 30 to lower the transmissivity position of the yellow beam (the wavelength is about 578 nm), referring to FIG. 5 as shown in the dotted line, and filter the yellow beam. Therefore, as the present invention is used in a briefing, as shown in FIG. 6(A), the driver 31 can move the band-cut filter 30 out of the light path so that the color generation assembly 22 of the projection system 20 can keep the strong yellow beam being covered within the red beam and green beam to get optimum brightness to display high brightness projection efficiency. In contrast, as shown in FIG. 6(B), as the present invention is used in seeing movies, the driver 31 can move the band-cut filter 30 in the light path to filter the yellow beam which is covered in the red beam and green beam so that the projection screen can get optimum color performance to display the high color saturation.

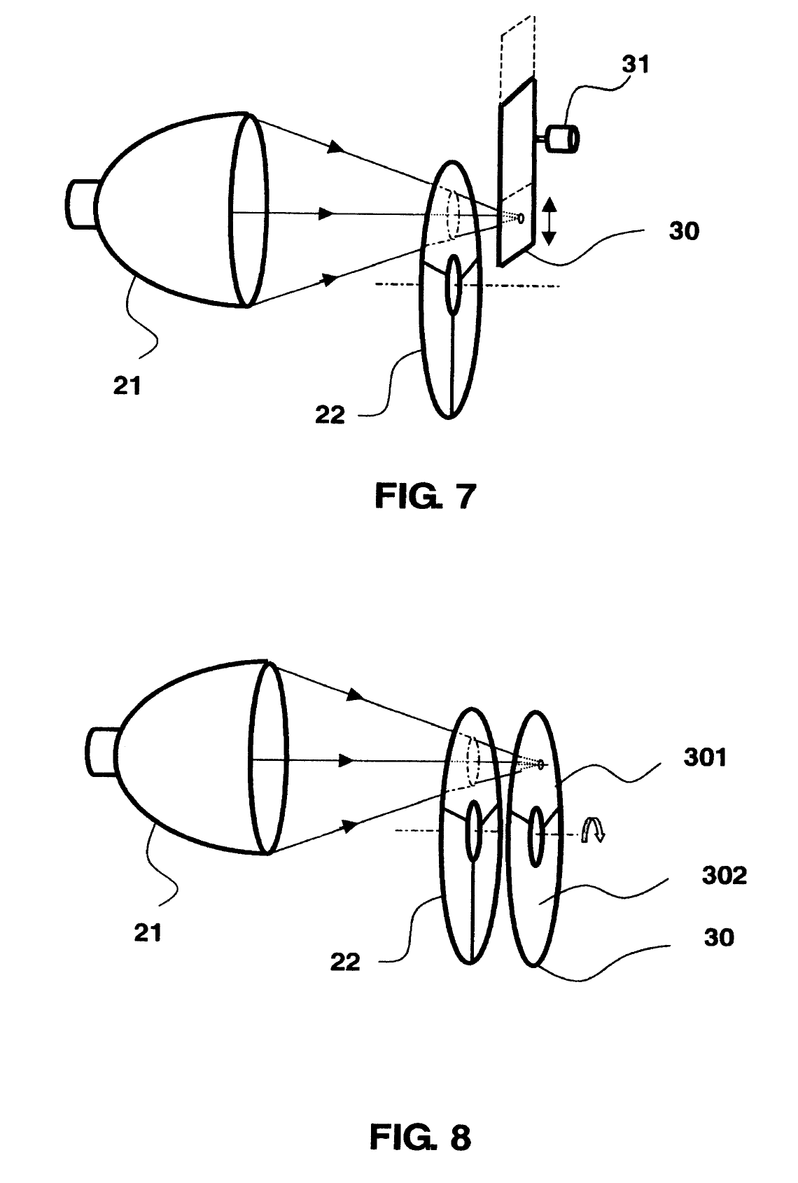

Referring to FIG. 7, the present invention uses the driver 31 (e.g. manual or motor) to properly select the band-cut filter 30, which is a long-plank shape and has a yellow filter segment, to move in or out the light path of the projection system 20 by means of moving horizontally or rotating by fixing angle. So a projector can have two types of high brightness and high color saturation. It is suitable for briefing or seeing movies in different function.

In addition, the band-cut filter 30 of the present invention can cooperate with the frequency of the red filter and the green filter of the color generation assembly 22. By means of the driver 31, the frequency of moving the band-cut filter 30 into the light path is synchronized to the red filter or the green filter. As shown in FIG. 6(C) and FIG. 6(D), select to filter the yellow beam within the red beam or the green beam to sacrifice some color saturation for keeping some energy of the yellow beam and reducing energy loss of the yellow beam to get more brightness. This forms a normal brightness and normal color saturation mode to satisfy the different color choices of the consumer.

As shown in FIG. 8, the color generation assembly 22 is a color wheel form, and another embodiment of the band cut filter 30 is also a color wheel form which has a yellow filter segment 301 to filter the yellow beam and the other transparent segment 302 without adding any devices or adding a transparent glass or an anti-reflection coating glass to pass other color lights smoothly. Then, the rotational frequency of the band-cut filter 30 is synchronized to the rotational frequency of the color wheels of the color generation assembly 22. The band-cut filter 30 can be driven by a separate driver or by the color wheel of the color generation assembly 22. Then, the yellow filter segment 301 is set to synchronized to the red filter or the green filter of the color generation assembly 22. As the color generation assembly 22 filtering, the band-cut filter 30 properly filters the yellow beam within the red beam or the green beam to get different brightness and color saturation modes.

The above-mentioned embodiments are described to selectively filter the yellow beam, with the band-cut filter 30 which is placed between the color generation assembly 22 and the integration rod 23. But in technically, the band-cut filter 30 can place in anywhere that the band-cut filter 30 can move into the light path of the projection system 20 to filter the yellow beam, e.g. between the light source 21 and color generation assembly 22, between the color integration rod 23 and the illuminating lens assembly 24, between the light valve 26 and a images lens assembly 27, or between the images lens assembly 27 and the screen 28. In addition, the color generation assembly 22 in accordance to demand to set the 50% transmissivity position of cut out of the green filter is larger or equal to the 578 nm wavelength or set the 50% transmissivity position cut in of the red filter is less or equal to the 578 nm wavelength to get more projection brightness modes.

It will be apparent to those skilled in the art that in light of the forgoing disclosure, many alternations and modifications are possible in the practice of this invention without departing from the spirit or scoop thereof. Accordingly, the scoop of the invention is to be considered in accordance with the substance defined in the following claims.

What is claimed is:

1. A multi-function projection system, comprising:
a light source which provides a light beam;
a color generation assembly which has at least one red, one green, and one blue filter to filter said light beam;
and
a band-cut filter which has at least one yellow beam filter segment to selectively move into said light beam.

2. The multi-function projection system according to claim 1, wherein said light source is a metal halide lamp.

3. The multi-function projection system according to claim 1, wherein said light source is an ultra high pressure lamp.

4. The multi-function projection system according to claim 1, wherein a transmissivity position of cut out of said green filter is larger or equal to 578 nm wavelength.

5. The multi-function projection system according to claim 1, wherein a 50% transmissivity position of cut out of said green filter is larger or equal to 578 nm wavelength.

6. The multi-function projection system according to claim 1, wherein a transmissivity position of cut in of said red filter is less or equal to 578 nm wavelength.

7. The multi-function projection system according to claim 1, wherein a 50% transmissivity position of cut in of said red filter is less or equal to 578 nm wavelength.

8. The multi-function projection system according to claim 1, wherein a filtering wavelength of said yellow beam filter of said band-cut filter is limited around 578 nm wavelength.

9. The multi-function projection system according to claim 1, wherein said band-cut filter has a driver.

10. The multi-function projection system according to claim 9, wherein said driver is manual.

11. The multi-function projection system according to claim 9, wherein said driver is a motor.

12. The multi-function projection system according to claim 1, wherein frequency of moving said band-cut filter into a light path is synchronized to said red filter to filter the yellow beam within the red beam.

13. The multi-function projection system according to claim 1, wherein frequency of moving said band-cut filter into the light path is synchronized to said green filter to filter the yellow beam within the green beam.

14. The multi-function projection system according to claim 1, wherein frequency of moving said band-cut filter into the light path is synchronized to said red and green filter to filter the yellow beam within the red and green beam.

15. The multi-function projection system according to claim 1, wherein said band-cut filter keeps out of the light path of said light beam.

16. The multi-function projection system according to claim 1, wherein said projection system further comprises a screen to receive said beam of said light source, said band-cut filter being placed between said light source and said screen.

17. The multi-function projection system according to claim 1, wherein said projection system further comprises an integration rod after said color generation assembly, said band-cut filter being placed between said color generation assembly and said integration rod.

18. The multi-function projection system according to claim 1, wherein said band-cut filter is a color wheel form which has at least one yellow filter segment and the other is transparent segment.

19. The multi-function projection system according to claim 18, wherein said transparent segment can coat an anti-reflection.

20. The multi-function projection system according to claim 1, wherein said band-cut filter is a long plank upon which has at least one yellow filter segment.
